(19) United States
(12) Patent Application Publication
(10) Pub. No.: US 2025/0023399 A1
(43) Pub. Date: Jan. 16, 2025

(54) ELECTRIC WATER PUMP WITH OVER-MOLDING STATOR

(71) Applicant: COAVIS, Sejong-si (KR)

(72) Inventors: Hyuntae LEE, Sejong-si (KR); Wookeun LEE, Sejong-si (KR); Yonghwan CHOI, Daejeon (KR); Dongheon MO, Sejong-si (KR)

(73) Assignee: COAVIS, Sejong-si (KR)

(21) Appl. No.: 18/765,416

(22) Filed: Jul. 8, 2024

(30) Foreign Application Priority Data
Jul. 10, 2023 (KR) 10-2023-0088918

(51) Int. Cl. H02K 1/14; F04D 13/06; H02K 7/08; H02K 7/14

(52) U.S. Cl. CPC H02K 1/14; F04D 13/0633; H02K 7/08; H02K 7/14

(57) ABSTRACT

Provided is an electric water pump with an over-molding stator for improving a flow structure and a dimensional accuracy in the water pump. The pump largely includes: a stator including a rotor accommodation part accommodating a rotor and a plurality of coils arranged around a rotating shaft of the rotor in a circumferential direction; and a molding part surrounding the stator to insulate the plurality of coils, wherein the molding part is injected onto the stator to surround the entire coil while having a plurality of flow paths formed between the coils and passing through in a direction of the rotating shaft.

### CROSS-REFERENCE TO RELATED APPLICATIONS

This application claims priority under 35 U.S.C. § 119 to Korean Patent Application No. 10-2023-0088918, filed on Jul. 10, 2023, in the Korean Intellectual Property Office, the disclosure of which is incorporated herein by reference in its entirety.

### TECHNICAL FIELD

The following disclosure relates to an electric water pump with an over-molding stator, in which a motor is driven to rotate an impeller, and more particularly, to an electric water pump with an over-molding stator for improving a flow structure and a dimensional accuracy in the water pump.

### BACKGROUND

A water pump is a device for circulating a coolant to an engine or a heater for engine cooling, interior heating, or the like. This water pump is largely classified into a mechanical water pump and an electric water pump.

The mechanical water pump is a pump connected to a crankshaft of the engine and driven based on a rotation of the crankshaft, and the electric water pump is a pump driven by a rotation of a motor controlled by a control device.

Here, the electric water pump may be driven by electricity regardless of an engine rotation, thus making it easy to control and adjust a flow rate of the coolant. Therefore, a rate of applying the electric water pump to a vehicle is currently increasing.

A conventional electric water pump adopts a method of rotating a rotor by flowing a current through a coil formed around the rotor. Therefore, in general, a sealing member may be added to waterproof components around the coil, or the respective components may be waterproof and then individually assembled.

However, this conventional method of individually waterproofing and then re-assembling the components may require more components and more processes that are necessary for the waterproofing, which may result in the lower productivity and higher manufacturing costs of the pump. In addition, this method of re-assembling the plurality of components may be vulnerable to vibration, which may cause lower durability of the pump.

### RELATED ART DOCUMENT

### [Patent Document]

KR 10-2015-0052436 A (May 14, 2015)

### SUMMARY

An object of the present disclosure is to provide an electric water pump with an over-molding stator, in which the stator having a rotor interposed therein is integrally over-molded, and a flow path is formed in the stator without affecting its dimensional accuracy.

Another object of the present disclosure is to provide an electric water pump capable of being electrically connected to the outside.

In one general aspect, an electric water pump includes: a stator including a rotor accommodation part accommodating a rotor and a plurality of coils arranged around a rotating shaft of the rotor in a circumferential direction; and a molding part surrounding the stator to insulate the plurality of coils, wherein the molding part is injected onto the stator to surround the entire coil while having a plurality of flow paths formed between the coils and passing through in a direction of the rotating shaft.

The stator may include a plurality of teeth which protrude in a direction of the rotor accommodation part, and around each of which the coil is capable of being wound, and the tooth may have an inner peripheral surface adjacent to the rotor accommodation part, extending in a circumferential direction, and having an area of a vertical area of the tooth, around which the coil is wound, or greater.

The inner peripheral surface of the tooth, which is adjacent to the rotor accommodation part, may have a predetermined gap with that of the adjacent tooth, and the flow path may communicate with the rotor accommodation part.

The molding part may be injected to surround the stator in all directions while exposing the inner peripheral surface of the tooth, which is adjacent to the rotor accommodation part.

The pump may further include a terminal electrically connected and coupled to the stator while having the same axis as the stator.

The molding part may be injected onto the stator and the terminal to thus be integrated with the stator and the terminal.

The terminal may further include an electrode protruding outward, and the molding part may be injected onto the stator and the terminal to expose the electrode.

The terminal may include a circular inner terminal and an outer terminal that is formed concentrically with the inner terminal, and the inner terminal and the outer terminal may be connected to each other while having a distribution port formed therebetween and corresponding to the flow path.

The inner terminal may protrude upward to have the rotating shaft accommodation part in which the rotating shaft of the rotor and a bearing formed on the rotating shaft are coupled and fixed to each other.

Other features and aspects will be apparent from the following detailed description, the drawings, and the claims.

### BRIEF DESCRIPTION OF THE DRAWINGS

FIG. 1 is a perspective view of an electric water pump according to the present disclosure.

FIG. 2 is a cross-sectional view of the electric water pump according to the present disclosure.

FIG. 3 is a perspective view showing the upper portion and lower portion of an over-molding stator according to the present disclosure.

FIGS. 4A and 4B are cross-sectional views of the over-molding stator according to the present disclosure.

FIG. 5 is a cross-sectional view of the over-molding stator according to the present disclosure.

FIGS. 6A, 6B, and 6C are flowcharts showing a portion of a manufacturing process of the over-molding stator according to the present disclosure.

FIG. 7 is a perspective view and an enlarged view each showing a portion of the over-molding stator according to the present disclosure.

### DETAILED DESCRIPTION OF EMBODIMENTS

Hereinafter, a technical spirit of the present disclosure is described in more detail with reference to the accompanying drawings. Prior to the description, terms and words used in the specification and claims are not to be construed as general or dictionary meanings, and are to be construed as meanings and concepts meeting the spirit of the present disclosure based on a principle in which the inventors may appropriately define the concepts of the terms in order to describe their inventions in the best mode. Therefore, configurations described in the embodiments and accompanying drawings of the present disclosure are merely the most preferable embodiments, rather than representations of the full scope of the present disclosure. Therefore, the present disclosure should be construed as including all the changes and substitutions included in the spirit and scope of the present disclosure at the time of filing this application.

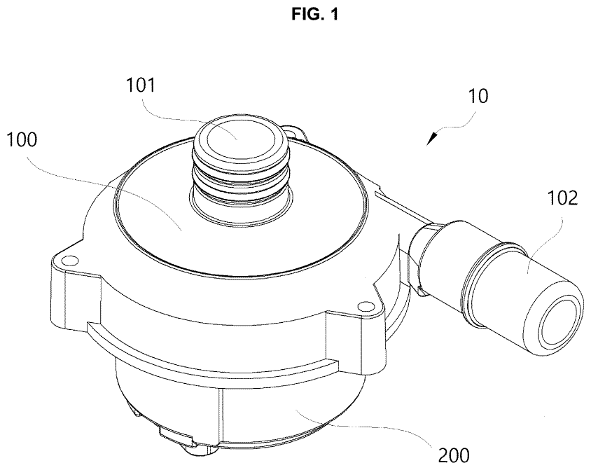

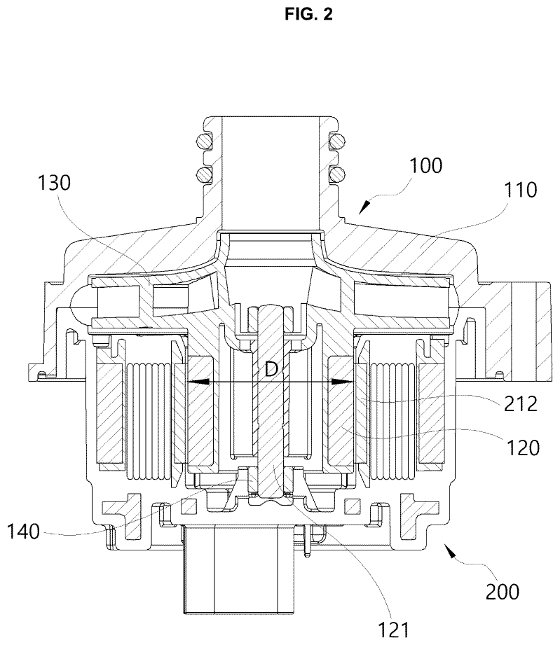

FIGS. 1 and 2 show an overall appearance of an electric water pump 10 according to the present disclosure. The electric water pump 10 according to an embodiment of the present disclosure may largely include an over-molding stator 200 and an upper assembly 100 coupled to the over-molding stator 200, as shown in the drawings.

In more detail, the over-molding stator 200 may include a stator 210 having a rotor accommodation part 201 accommodating the upper assembly 100 and a molding part 220 surrounding and insulating the stator 210; and the upper assembly 100 may include an upper casing 110 fastened to the molding part 220, a rotor 120 having a rotating shaft 121 interposed therein, and an impeller 130 rotated together with the rotor 120 to flow a fluid.

Here, the upper casing 110 may include an inlet 101 extending from the top of the pump and communicating with its center, and an outlet 102 disposed in a discharge direction of the impeller 130. The impeller 130 may be rotated by the rotor 120, and generate a pressure through the rotation to thus pump the fluid from the inlet 101 to the outlet 102.

In addition, the rotor 120 and the rotating shaft 121 may generate a rotational force through a magnetic force when a current is applied to the stator 210 by a principle of an electric motor. The impeller 130 may extend from the rotor 120, and receive the rotational force of the rotor 120 and the rotating shaft 121 to pump the fluid as described above.

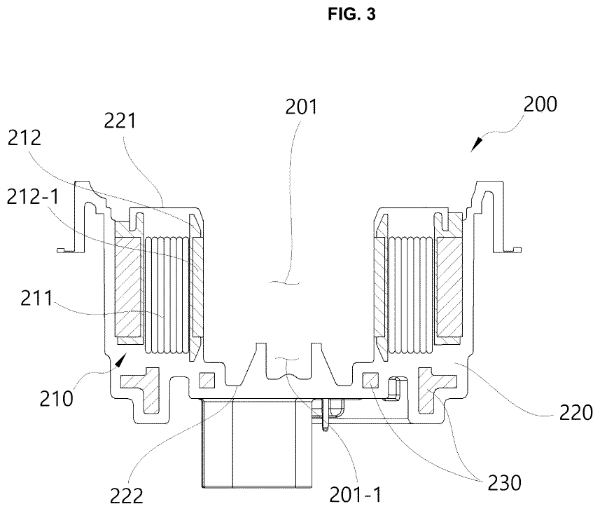

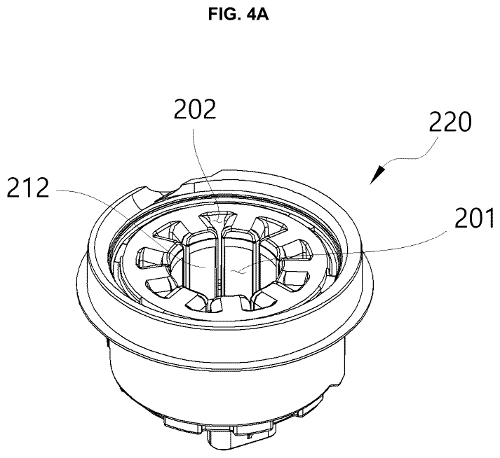

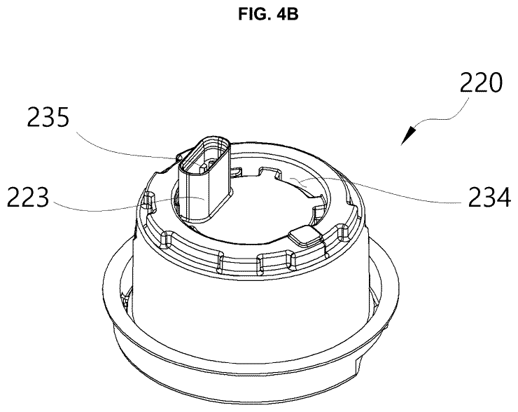

FIGS. 3 and 4 show the over-molding stator 200 from which the upper assembly 100 is separated from the electric water pump 10 according to the present disclosure. As shown in the drawings, the over-molding stator 200 may include the stator 210 and the molding part 220.

In more detail, the stator 210 may include the rotor accommodation part 201 accommodating the rotor 120, and a plurality of coils 211 arranged around the rotating shaft 121 in a circumferential direction. The rotor accommodation part 201 may preferably be hollow while having a circular horizontal cross-section for the rotor 120 to be rotated therein. Here, referring to FIG. 2 together, it may preferably be designed so that a diameter D of the rotor accommodation part 201 is larger than a diameter of the rotor 120 by a certain numerical value, and the rotor 120 and teeth 212 have a predetermined gap therebetween.

In addition, the stator 210 may include the plurality of teeth 212 protruding inward to form the rotor accommodation part 201. The coil 211 may be wound around each of the plurality of teeth 212. Here, the teeth 212 may be designed so that its front portion where the coil 211 is not wound has an area greater than an area of the coil 211 to prevent the coil 211 from being exposed to the rotor accommodation part 201.

In addition, the molding part 220 may be formed by injecting a molding member by performing over-molding to surround the stator 210 in all directions. The molding part 220 may be provided for waterproofing components that require insulation, such as the coil 211 included in the stator 210, and thus preferably be injected to be compatible with the upper assembly 100. That is, the number of processes may be minimized by performing an over-molding process on the stator 210 having all the necessary components assembled together without manufacturing a separate component for casing the stator 210.

Here, as shown in the drawings, it may be preferable that the molding part 220 is injected to surround the stator 210 in all the directions while exposing an inner peripheral surface 212-1 of the tooth 212, which is adjacent to the rotor accommodation part 201. The reason is to secure dimensional accuracy for maintaining the gap between the teeth 212 and the rotor 120 as described above in consideration of the compatibility of the molding part 220 with the rotor 120. As described above, the front portion of the tooth 212 may completely cover the coil 211, and the molding part 220 may fill its surrounding area, thereby insulating the stator 210 from all the directions. That is, the molding part 220 may be injected onto the stator 210 while not affecting dimensions initially designed for its compatibility with the rotor 120, thus minimizing the number of processes for post-processing.

In addition, referring to FIG. 2 together, the upper assembly 100 may be interposed in the rotor accommodation part 201, and seated on each of the upper surface 221 and lower surface 222 of the molding part 220. Here, the impeller 130 and the upper surface 221 may be seated while having a predetermined gap therebetween. In addition, a rotating shaft accommodation part 201-1 extending from the rotor accommodation part 201 may be formed in the lower surface 222. It may be preferable that the rotating shaft accommodation part 201-1 has a corresponding shape allowing the rotating shaft 121 to maintain its rotation center, and is designed in a shape allowing a bearing 140, which is required for the rotating shaft 121 to be rotated with respect to the stator 210, to be coupled thereto. Accordingly, the pump 10 may omit a bushing supporting a conventional rotating shaft at its bottom, which may result in a lighter weight and a lower cost.

Here, referring to FIG. 4A, the molding part 220 may be injected onto the stator 210 to have a plurality of flow paths 202 formed between the coils 211 and passing through in a direction of the rotating shaft. The plurality of flow paths 202 may bypass a portion of the fluid circulated in the upper assembly 100 to pass through a periphery of the coil 211. That is, the electric water pump 10 according to the present disclosure may achieve a cooling effect by allowing the circulated fluid to enter the over-molding stator 200.

In addition, FIG. 4B shows a lower portion of the over-molding stator 200. Referring to FIG. 3 together, the pump 10 may further include a terminal 230 electrically connected and coupled to the stator 210 while having the same axis as the stator 210, and the molding part 220 may be injected onto the stator 210 and the terminal 230 to thus be integrated with the stator 210 and the terminal 230. Here, an electrode 235 connected to the terminal 230 may be exposed to the bottom of the molding part 220, and the molding part 220 may further include an electrode molding part 223 insulating a periphery of the electrode 235 as much as possible and protecting the electrode 235.

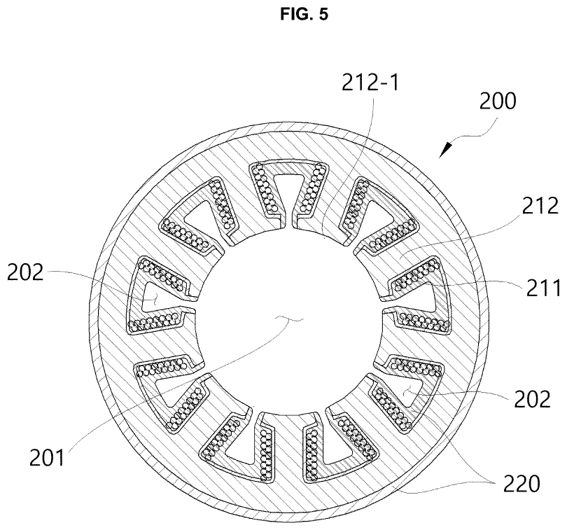

FIG. 5 shows a cross-section of the over-molding stator 200 to more specifically explain the over-molding stator 200 of the electric water pump 10 according to the present disclosure. As shown in the drawing, the stator 210 may have a circular cross-section. The stator 210 may include the plurality of teeth 212 arranged radially and extending inwardly.

Here, the plurality of teeth 212 may have a predetermined space formed therebetween, and the coil 211 may be wound around each tooth 212. The teeth 212 may form the rotor accommodation part 201 through the inner peripheral surfaces 212-1 of their front portions. The inner peripheral surfaces 212-1 may each be designed to extend a predetermined length in the circumferential direction and have a predetermined gap therebetween.

Here, the inner peripheral surface 212-1 of the tooth 212 may be designed to cover the front portion of the coil 211 by having an area of a width of the wound coil 211 or greater, which may prevent the coil 211 from being exposed because the tooth 212 is impacted or worn by the rotor 120.

In addition, as shown in the drawing, the molding part 220 may be injected onto the stator 210 in all the directions while having a flow path 202 formed between the coils 211. That is, the molding part 220 may have the flow path 202 by leaving a predetermined portion of space between the teeth 212 while being injected into the space between the teeth 212 to completely cover the coil 211. Through this configuration, a portion of the fluid circulated in the upper assembly 100 may be bypassed to pass through the periphery of the coil 211, thereby achieving the cooling effect.

Here, as an example, the molding part 220 may be injected so that the flow path 202 is connected to the rotor accommodation part 201. Through this configuration, the fluid entering through the flow path 202 may spread between the rotor 120 and the inner peripheral surface 212-1, thereby reducing a friction therebetween during the rotation of the rotor 120 and achieving the cooling effect.

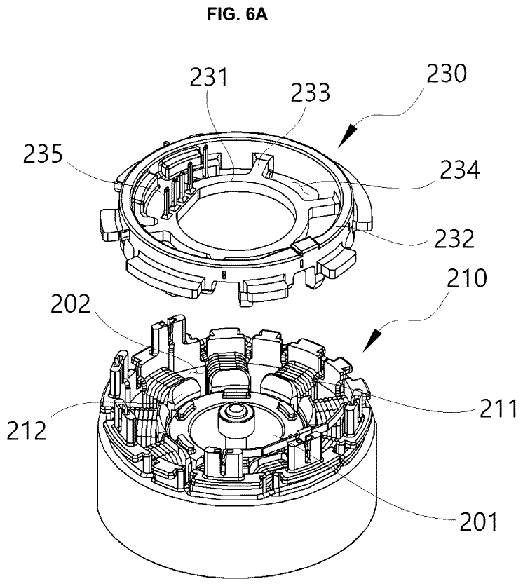

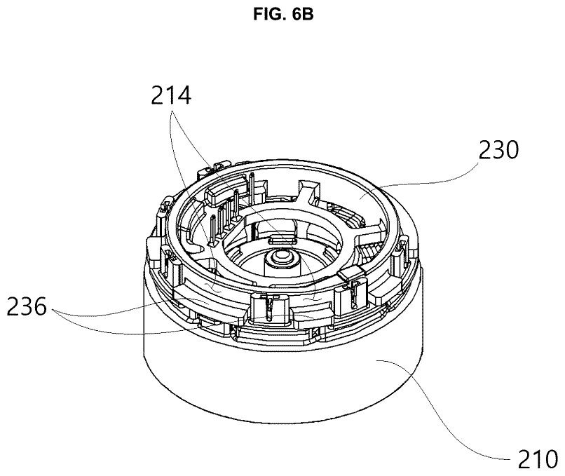

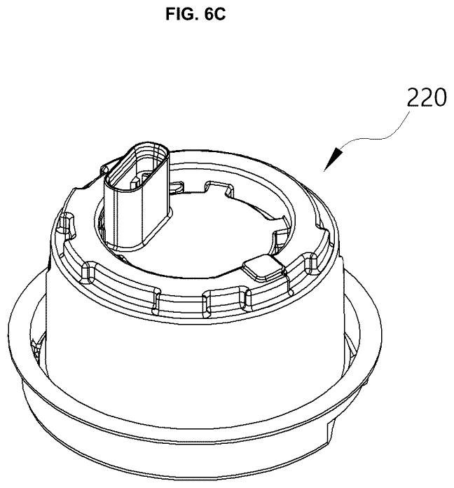

FIG. 6 is a flowchart showing a portion of a manufacturing process of the electric water pump 10 according to an embodiment of the present disclosure. The manufacturing process of the electric water pump 10 may include an assembling process of the terminal 230 and performing electrical wiring in advance before the over-molding process.

As an example, the terminal 230 may be seated below the stator 210. The terminal 230 may be a component allowing the stator 210 to receive power and electrical signals from the outside, and include a circular inner terminal 231, an outer terminal 232 that is formed concentrically with the inner terminal 231, a connection part 233 connecting the inner terminal 231 with the outer terminal 232, and the electrode 235 exposed to the outside. The terminal 230 may have this shape to minimize an overall volume of the over-molding stator 200 and reduce its weight while being seated on the bottom of the stator 210.

Here, the terminal 230 may further include a distribution port 234 formed between the inner terminal 231 and the outer terminal 232 and corresponding to the flow path 202. As shown in FIG. 6C, the present disclosure may include every embodiment in which the distribution port 234 is maintained even after being over-molded, or has the bottom completely sealed while leaving a predetermined depth. That is, the distribution port 234 may be a component allowing the fluid entering through the flow path 202 to enter a periphery of the terminal 230 and cool the terminal 230 and its periphery together.

In addition, as shown in FIG. 6B, the terminal 230 may include a plurality of wings 236 protruding outward from the outer terminal 232. The wing 236 may be interposed in a slot 214 formed in a lower portion of the stator 210. Here, the plurality of wings 236 may be formed on an outer peripheral surface of the outer terminal 232 in the circumferential direction, and some wings 236 may have an extending length different from those of the adjacent wings 236. The purpose of this difference is to easily seat the terminal 230 in a correct direction when the terminal 230 is seated on the stator 210.

Then, as shown in FIG. 6C, the molding member may be finally injected onto the stator 210 and the terminal 230 to thus be integrated with the stator 210 and the terminal 230, thereby forming the molding part 220.

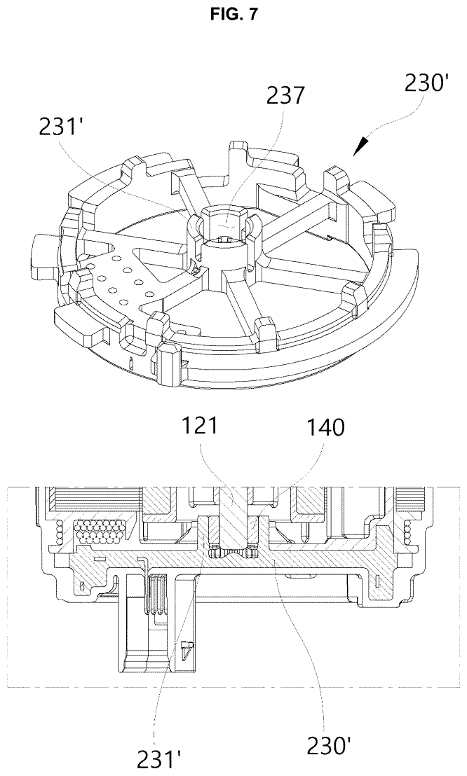

FIG. 7 shows a terminal 230′ of the electric water pump 10 according to another embodiment of the present disclosure. The terminal 230′ has a modified form of the inner terminal in an embodiment shown in FIG. 6 described above. As shown in FIG. 7, a rotating shaft accommodation part 237 may be formed directly on the terminal 230′ without forming the rotating shaft accommodation part through the molding part.

The terminal 230′ may be designed to interpose the rotating shaft 121 and a bearing 140 within a diameter of an inner terminal 231′. Here, the inner terminal 231′ may be shaped to minimize vibration occurring in the rotating shaft 121 and protrude to a sufficient height to allow the bearing 140 to be coupled to the rotating shaft 121. That is, the terminal 230′ may not only be used for the electrical wiring, but also be provided as a component for fixing a shaft, such as the rotating shaft accommodation part 237. Therefore, the pump 10 may omit the bushing supporting the conventional rotating shaft at the bottom, as in the embodiment described above, thereby achieving the lighter weight and the lower cost. In addition, before the over-molding process, the terminal 230′ may be coupled in advance with the stator 210 and the rotating shaft 121, thereby further improving the designed dimensional accuracy.

As set forth above, in the electric water pump according to the present disclosure, the fluid may be allowed to flow into the over-molding stator while insulating the stator, thereby achieving the additional cooling effect.

In addition, in the electric water pump according to the present disclosure, the stator may be insulated without interfering with the previously designed dimensional accuracy.

The present disclosure is not limited to the above-described embodiments, may be variously applied, and may be variously modified by any of those skilled in the art to which the present disclosure within an equivalent range of the present disclosure claimed in the appended claims.

What is claimed is:

1. An electric water pump comprising:
a stator including a rotor accommodation part accommodating a rotor and a plurality of coils arranged around a rotating shaft of the rotor in a circumferential direction; and
a molding part surrounding the stator to insulate the plurality of coils,
wherein the molding part is injected onto the stator to surround the entire coil while having a plurality of flow paths formed between the coils and passing through in a direction of the rotating shaft.

2. The pump of claim 1, wherein the stator includes a plurality of teeth which protrude in a direction of the rotor accommodation part, and around each of which the coil is capable of being wound, and
the tooth has an inner peripheral surface adjacent to the rotor accommodation part, extending in a circumferential direction, and having an area of a vertical area of the tooth, around which the coil is wound, or greater.

3. The pump of claim 2, wherein the inner peripheral surface of the tooth, which is adjacent to the rotor accommodation part, has a predetermined gap with that of the adjacent tooth, and
the flow path communicates with the rotor accommodation part.

4. The pump of claim 2, wherein the molding part is injected to surround the stator in all directions while exposing the inner peripheral surface of the tooth, which is adjacent to the rotor accommodation part.

5. The pump of claim 1, further comprising a terminal electrically connected and coupled to the stator while having the same axis as the stator.

6. The pump of claim 5, wherein the molding part is injected onto the stator and the terminal to thus be integrated with the stator and the terminal.

7. The pump of claim 6, wherein the terminal further includes an electrode protruding outward, and
the molding part is injected onto the stator and the terminal to expose the electrode.

8. The pump of claim 6, wherein the terminal includes a circular inner terminal and an outer terminal that is formed concentrically with the inner terminal, and
the inner terminal and the outer terminal being connected to each other, and
further includes a distribution port formed between the inner terminal and the outer terminal and corresponding to the flow path.

9. The pump of claim 8, wherein the inner terminal protrudes upward to have the rotating shaft accommodation part in which the rotating shaft of the rotor and a bearing formed on the rotating shaft are coupled and fixed to each other.
